(19) United States
(12) Patent Application Publication
(10) Pub. No.: US 2002/0029625 A1
(43) Pub. Date: Mar. 14, 2002

(54) Vehicle electrical apparatus

(76) Inventor: Derron Reichard, Marlton, NJ (US)

Correspondence Address: Matthew J. Peirce, Esq., 1550 Starlight Canyon Avenue, Las Vegas, NV, 89123, US

(21) Appl. No.: 09/909,761

(22) Filed: Jul. 20, 2001

Related U.S. Application Data
(60) Provisional application No. 60/219,605, filed on Jul. 21, 2000.

(51) Int. Cl. G01M 19/00

(52) U.S. Cl. 73/118.1

(57) ABSTRACT

A new and improved apparatus is disclosed which would allow a user to determine if a specific spark plug and spark plug wire combination is good or needs to be replaced. The apparatus would include a tool that fits between a spark plug wire and the distributor cap on a vehicle. A separate wire connects the tool to a grounded clip, with the separate wire including a centrally-mounted button. When a user would push the centrally-mounted button, the spark plug wire is grounded and lets the user know if that particular spark plug wire is still capable of carrying an electronic charge or needs to be replaced. The present invention also keeps a user from shocking himself or herself and only requires one person to run.

### I. BACKGROUND OF THE INVENTION

The present invention concerns that of a new and improved apparatus which would allow a user to determine if a specific spark plug and spark plug wire combination is good or needs to be replaced.

### II. DESCRIPTION OF THE PRIOR ART

U.S. Pat. No. 5,652,381, issued to Fuchs, discloses an ignition system instrument used on spark ignited engines and includes a housing having a spark chamber.

U.S. Pat. No. 4,020,413, issued to Wetherbee, discloses a device for alternate use as an emergency replacement coil and condenser unit or as a tester of automobile spark plugs.

U.S. Pat. No. 1,974,275, issued to Janovitch, discloses improved form of a testing device for use in determining the operativeness of electric devices and for locating breaks in metal and other electric conductive materials.

### III. SUMMARY OF THE INVENTION

The present invention concerns that of a new and improved apparatus which would allow a user to determine if a specific spark plug and spark plug wire combination is good or needs to be replaced. The apparatus would include a tool that fits between a spark plug wire and the distributor cap on a vehicle. A separate wire connects the tool to a grounded clip, with the separate wire including a centrally-mounted button. When a user would push the centrally-mounted button, the spark plug wire is grounded and lets the user know if that particular spark plug wire is still capable of carrying an electronic charge or needs to be replaced. The present invention also keeps a user from shocking himself or herself and only requires one person to run.

There has thus been outlined, rather broadly, the more important features of an apparatus for testing a spark plug and spark plug wire combination in a vehicle in order that the detailed description thereof that follows may be better understood and in order that the present contribution to the art may be better appreciated. There are, of course, additional features of the apparatus for testing a spark plug and spark plug wire combination in a vehicle that will be described hereinafter and which will form the subject matter of the claims appended hereto.

In this respect, before explaining at least one embodiment of the apparatus for testing a spark plug and spark plug wire combination in a vehicle in detail, it is to be understood that the apparatus for testing a spark plug and spark plug wire combination in a vehicle is not limited in its application to the details of construction and to the arrangements of the components set forth in the following description or illustrated in the drawings. The apparatus for testing a spark plug and spark plug wire combination in a vehicle is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present apparatus for testing a spark plug and spark plug wire combination in a vehicle. It is important, therefore, that the claims be regard as including such equivalent constructions insofar as they do not depart from the spirit and scope of the present invention.

It is therefore an object of the present invention to provide an apparatus for testing a spark plug and spark plug wire combination in a vehicle which has all of the advantages of the prior art and none of the disadvantages.

It is another object of the present invention to provide an apparatus for testing a spark plug and spark plug wire combination in a vehicle which may be easily and efficiently manufactured and marketed.

It is another object of the present invention to provide an apparatus for testing a spark plug and spark plug wire combination in a vehicle which is of durable and reliable construction.

It is yet another object of the present invention to provide an apparatus for testing a spark plug and spark plug wire combination in a vehicle which is economically affordable and available to the buying public.

It is yet another object of the present invention to provide an apparatus for testing a spark plug and spark plug wire combination in a vehicle which provides additional benefits not present in the prior art.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a schematic view of the mechanical configuration of the present invention.

### V. DESCRIPTION OF THE PREFERRED EMBODIMENT

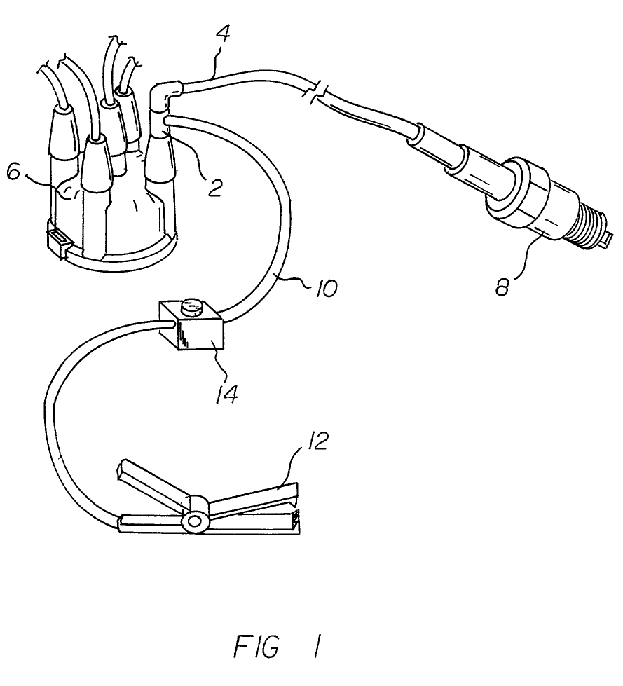

FIG. 1 shows a schematic view of the mechanical configuration of the present invention. The present invention concerns that of a new and improved apparatus which would allow a user to determine if a specific spark plug and spark plug wire combination is good or needs to be replaced. The apparatus would include an electrical connector 2 that fits between spark plug wire 4 and the distributor cap 6 on a vehicle. Spark plug wire 4 is connected to spark plug 8, which would be one of several spark plugs located on a particular vehicle.

A separate wire 10 connects the electrical connector 2 to a grounded clip 12, with the separate wire 10 including a centrally-mounted button 14. Centrally-mounted button 14 would be attached to separate wire 10 approximately halfway between electrical connector 2 and grounded clip 12. When a user would push centrally-mounted button 14, spark plug wire 4 is grounded and lets the user know if that particular spark plug wire 4 is still capable of carrying an electronic charge or needs to be replaced. The present invention also keeps a user from shocking himself or herself and only requires one person to run.

Once centrally-mounted button 14 would be pressed, the voltage from the distributor cap 6 or coil pack is directed to grounded clip 12 which is clipped somewhere on the body or engine block of the particular vehicle. By grounding this spark plug wire 4, a user could then tell by the way the engine would subsequently run, if that particular cylinder, spark plug and spark plug wire is working properly. If the applied spark plug wire 4 and spark plug 8 is good, the engine would run worse than it previously was. If the spark plug wire 4 and spark plug 8 would be bad, the engine would run the same as it previously was after the button 14 would be pushed.

The present invention itself would not be able to ascertain the exact cause of the electrical problem if a spark plug or spark plug wire was functioning incorrectly. However, the present invention would provide a good starting point for a user to research the potential problem further.

What I claim as my invention is:

1. An apparatus for testing a spark plug and spark plug wire combination in a vehicle comprising:
(a) a vehicle, the vehicle including an internal chassis and an engine,
(b) an electrical connector
(c) at least one spark plug
(d) a spark plug wire having two ends, a first end and a second end, the first end of the spark plug wire connected to the spark plug, the second end of the spark plug wire connected to the electrical connector,
(e) a clip,
(f) a connector wire having two ends, a first end and a second end, the first end of the connector wire connected to the clip, the second end of the connector wire connected to the electrical connector,
(g) a button connected to the connector wire approximately midway between the first end of the connector wire and the second end of the connector wire, the button acting as an electrical circuit between the first end of the connector wire and the second end of the connector wire, the button normally in an open-circuit position when not being depressed, the button acting as a closed circuit when depressed,
(h) whereby the clip would be attached to the chassis of the vehicle while the engine of the vehicle would be running, whereby a user would push the button to determine whether the spark plug and spark plug wire combination in the vehicle being tested would be functioning properly.

2. The process of determining the electrical conductivity of a spark plug wire and spark plug combination comprising the steps of:
(a) attaching a spark plug and spark plug wire combination to an electrical connector,
(b) attaching an electrical wire to the electrical connector, the electrical wire having two ends, a first end and a second end, the electrical wire having a button located approximately halfway between the first end and the second end of the electrical wire, the button acting as a circuit and normally being in an open circuit position when not being depressed, the first end of the electrical wire being the end connected to the electrical connector, the
(c) attaching a clip to the second end of the electrical wire,
(d) connecting the clip to the chassis of a vehicle,
(e) starting the engine of the vehicle, and
(f) closing the circuit on the electrical wire by pushing the button to determine whether the particular spark plug and spark plug wire being tested are working properly.
